(19) United States
(12) Patent Application Publication
(10) Pub. No.: US 2016/0309853 A1
(43) Pub. Date: Oct. 27, 2016

(54) ADJUSTABLE BELT WITH GEAR SYSTEM

(71) Applicant: Liam Daniel Snyder, Mission (CA)

(72) Inventor: Liam Daniel Snyder, Mission (CA)

(21) Appl. No.: 14/694,454

(22) Filed: Apr. 23, 2015

(51) Int. Cl. A44B 11/20; F16H 19/04; A41F 9/00

(52) U.S. Cl. CPC A44B 11/20; A41F 9/002; F16H 19/04; F16H 2019/046

(57) ABSTRACT

An adjustable belt for wearing around a user's waist is disclosed. The belt comprises a strap for placement around the user's waist. A buckle is coupled to a first end of the strap and is configured for accepting a second end of the strap and adjusting a length of the strap. The buckle further comprises a plurality of gears that mate with gear teeth located on an outward facing surface of the strap, such that movement of the second end of the strap within the buckle moves the plurality of gears; a spring loaded ratchet that contacts the gear teeth of the plurality of gears, such that the ratchet only allows movement of the plurality of gears in one direction; and a lever coupled to the spring loaded ratchet, such that activating the lever allows for movement of the plurality of gears in both directions.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of clothing, and more specifically to the field of belts.

### BACKGROUND

Almost every human in the world wears clothes. Clothing is fiber and textile material worn on the body. The wearing of clothing is a feature of nearly all human societies. Most people change their clothes on a daily basis. Such clothes include shirts, pants, shorts, dresses, skirts, blouses, suits, capri pants, tank tops etc. When wearing certain articles of clothing adapted to cover the lower parts of the body, such as pants, skirts, dresses, shorts, etc., many people choose to wear belts to help maintain such articles of clothing in the correct position.

Belts have been used for centuries for maintaining articles of clothing in the correct position. In the past, many belts have comprised an elongated strap having a first end opposing a second end and wherein a buckle or other attaching means is adapted to secure belt around an individual's waist. When a buckle is used on a belt, the buckle is typically affixed to one end of the strap and the second end of the strap has a plurality of evenly spaced holes adapted for receiving a prong of the buckle. When worn around a user's waist, the length of the strap of such belts can be adjusted by moving the prong from one hole to another hole.

One problem associated with the above existing type of belts is the inability to adjust for varying waist sizes. For example, an individual can have a belt comprising a strap having a set of predetermined belt holes. If such individual gains or loses weight, then such gain or loss of weight may cause such individual's waist size to change. As a result, such individual may require a belt having a strap with a hole in between the predetermined holes of the strap in order for the belt to properly fit such individual's waist. When this happens, such individual may be required to purchase a new belt, which creates an increase in expenses for such individual.

Other types of belts do exist that comprise buckles that do not use prongs. However, one problem with such belts is that the buckles lose the grip of the strap allowing such belts to loosen easily. When such types of buckles loosen, they require a person to continuously tighten the strap, which is inefficient and somewhat undesirable for the individual.

As a result of the above mentioned problems, there exists a need for improvement over the prior art for an improved buckle allowing for varying or fluctuating waist sizes.

### SUMMARY OF THE INVENTION

An adjustable belt is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an adjustable belt for wearing around a user's waist is disclosed. The belt comprises a strap for placement around the user's waist, the strap having a first end, a second end and an outward facing surface when placed around the user's waist. The belt further comprises a plurality of gear teeth located on the outward facing surface of the strap. A buckle is coupled to a first end of the strap and is configured for accepting a second end of the strap and adjusting a length of the strap around the user's waist. The buckle further comprises a plurality of gears having gear teeth that mate with the plurality of gear teeth located on the outward facing surface of the strap, such that movement of the second end of the strap within the buckle moves the plurality of gears. The buckle also includes a spring loaded ratchet that contacts the gear teeth of the plurality of gears, such that the ratchet only allows movement of the plurality of gears in one direction, and a lever coupled to the spring loaded ratchet, such that activating the lever withdraws the ratchet from contacting the gear teeth of the plurality of gears, thereby allowing movement of the plurality of gears in both directions.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a front perspective view of an adjustable belt, according to an example embodiment;

FIG. 2 is a rear perspective view of an adjustable belt, according to an example embodiment;

FIG. 3 is a front perspective view of an adjustable belt, according to another example embodiment;

FIG. 4 is a top view of the strap and buckle of the adjustable belt, wherein the inner components of the strap and buckle are visible, according to an example embodiment;

FIG. 5 is a perspective view of the strap and buckle of the adjustable belt, wherein the inner components of the strap and buckle are visible, according to an example embodiment;

FIG. 6 is a perspective view of the strap and buckle of the adjustable belt, wherein only certain inner components of the strap and buckle are visible, according to an example embodiment;

FIG. 7 is a rear view of the strap and buckle of the adjustable belt, wherein the inner components of the strap and buckle are visible, according to an example embodiment;

FIG. 8 is a front view of the strap and buckle of the adjustable belt in a disassembled state, according to an example embodiment;

FIG. 9 is a rear view of the strap and buckle of the adjustable belt in a disassembled state, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems of the prior art by providing a system for providing an adjustable belt with a buckle having a plurality of gears and a spring loaded ratchet. The system improves over the prior art by providing an adjustable belt that more efficiently allows for a fluctuating waistline. The belt also improves over the prior art by providing a belt that prevents a user from having to punch holes in a belt to accommodate for an increasing or decreasing waistline. The belt also improves over the prior art by providing a spring loaded ratchet that prevents a belt from loosening when worn by an individual. Further, the belt provides aesthetic value, since the inner working of the buckle (gears, etc.) are exposed and viewable, thereby creating a mechanical or industrial look and feel to the belt, such as the well-known steam-punk motif.

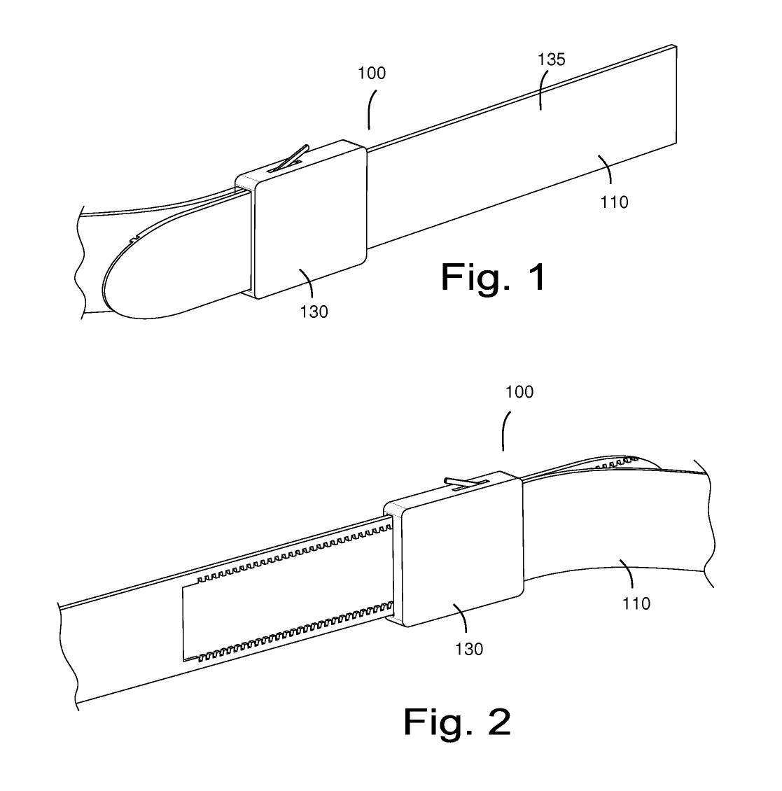

Referring to the Figures, FIG. 1 is a front perspective view of an adjustable belt 100, according to an example embodiment. The belt includes an elongated rectangular shaped strap 110 that is adapted for placement or to surround a user or individual's waist. The strap has a first end opposing a second end. When the strap is wrapped around or surrounds a user's waist, the strap has an outward facing surface 135 opposing and an inward facing surface. The strap may be made of material well known to those skilled in the art of belt making, such as leather, heavy cloth, synthetic materials, etc.

A buckle 130 is coupled to the first end of the strap. The buckle is configured for accepting a second end of the strap and for adjusting the length of the strap around the user's waist (further explained below). In one embodiment, the buckle can have a rectangular shaped body wherein the body has a top end opposing a bottom end and a first side and second side that spans from the top end to the bottom end. Other shapes can be used for buckle that are within spirit and scope of the invention. The buckle can be formed from plastic, metal, aluminum, brass etc. FIG. 2 is a rear perspective view of the adjustable belt, according to an example embodiment.

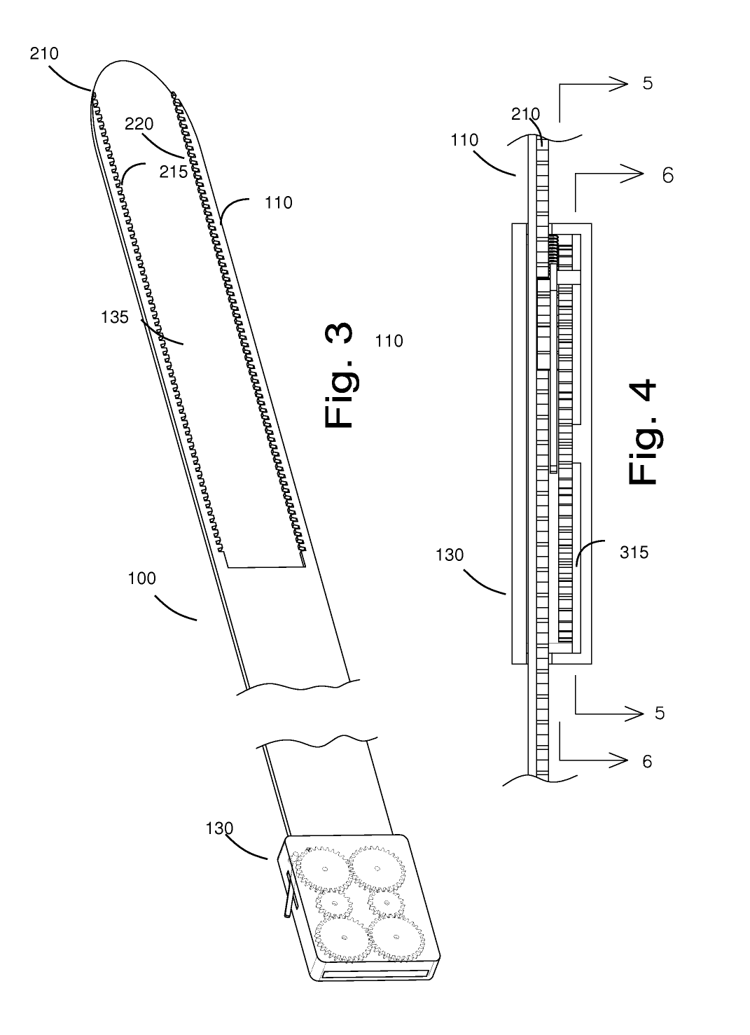

FIG. 3 is a front perspective view of an adjustable belt, according to another example embodiment. Note that while the embodiment of FIG. 1 shows no gears visible in the front of the buckle, the embodiment of FIG. 3 shows the gears visible in the front of the buckle and the gear teeth visible in the front of the strap. The embodiment of FIG. 3 illustrates the outward facing surface 135 of the strap when the strap is placed around a user's waist. A plurality of gear teeth 210 is located on the outward facing surface of the strap. In the present embodiment, the gear teeth are horizontally arranged (or linear). An upper or first strip 215 opposes a lower or second strip 220. The strip of upper teeth opposes and faces the strip of lower gear teeth. However, in other embodiments, one strip of horizontally arranged or linear gear teeth may be used. In the present embodiment, the gear teeth are rectangular shaped however other shapes of gear teeth may also be used.

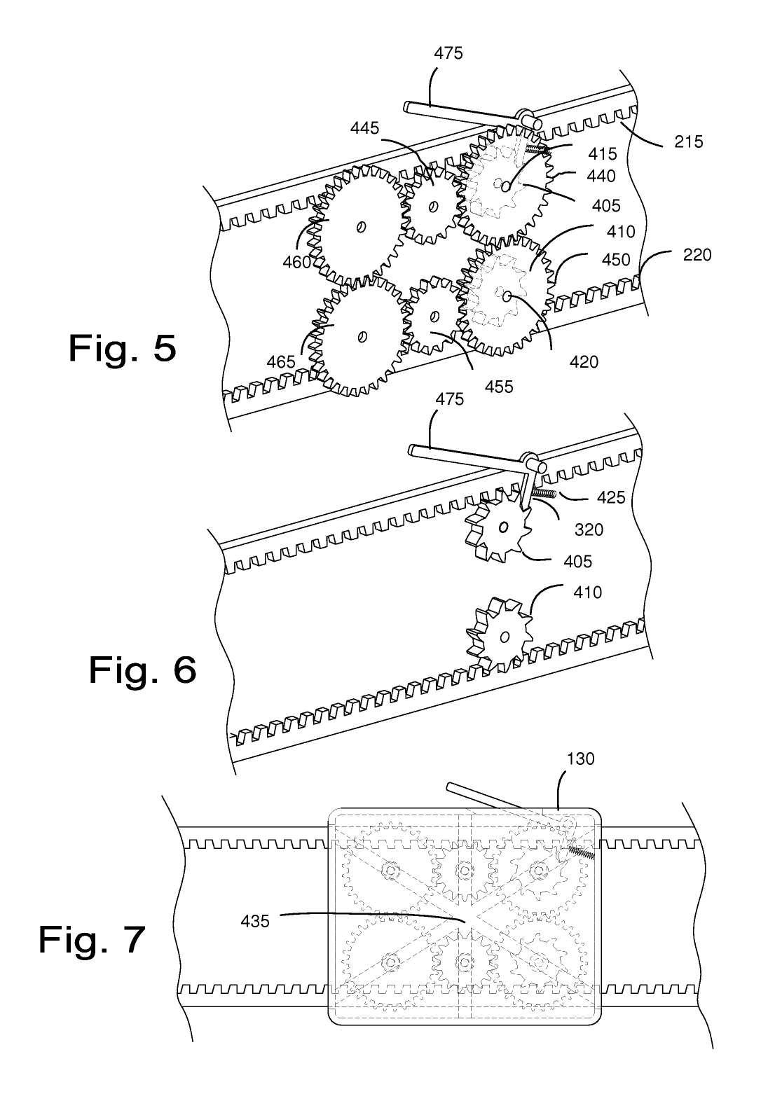

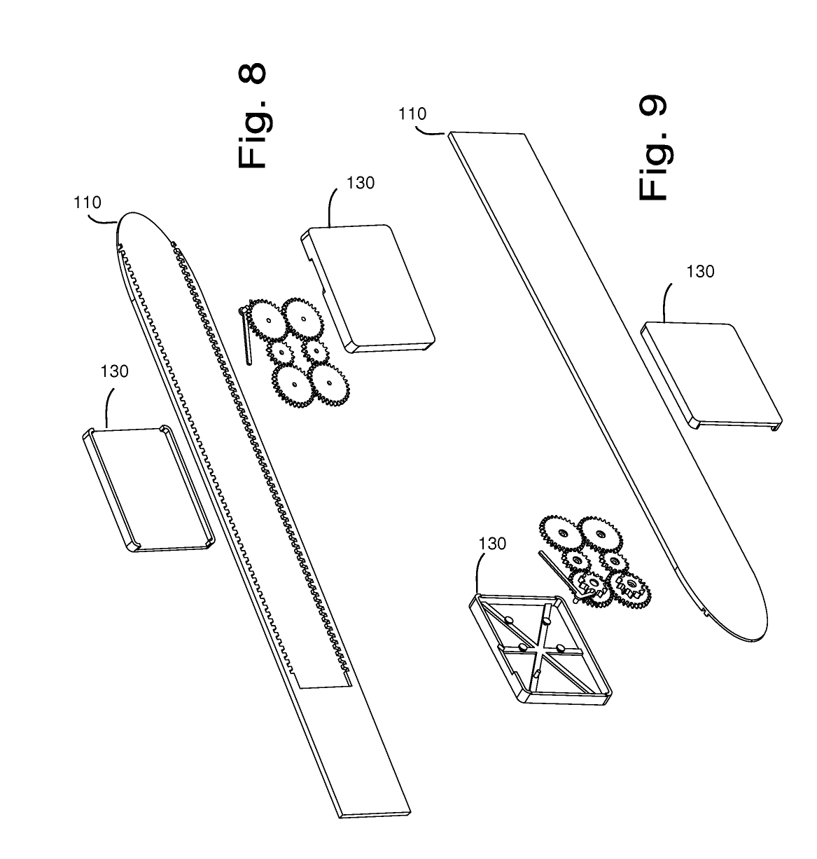

FIG. 4 is a top view of the strap 110 and buckle of the adjustable belt 100, wherein the inner components of the strap and buckle are visible, according to an example embodiment. FIG. 4 illustrates the elongated strap being received by the buckle. The buckle has a first opening on its first side and an opposing a second opening on its second side defining a slot that spans from the first end to the second end. The slot is adapted for allowing the second end of the strap to pass through the buckle. A plurality of gears 315 having gear teeth are located within the buckle and mate with the plurality of gear teeth 210 on the outward facing surface of the strap. The gears are adapted such that the movement of the second end of the strap within the buckle moves the plurality of gears. In the present embodiment, the plurality of gears are spur gears. A spring loaded ratchet contacts the gear teeth of at least one of the gears, thereby allowing the movement of the plurality of gears in both directions. A pawl 320 of the spring loaded ratchet is illustrated in FIG. 6 and more fully illustrated in FIGS. 5 and 6 and further explained below. Note that gear teeth 315 can be outwards facing and exposed to the outside viewer for aesthetic purposes.

FIG. 5 illustrates the components inside the housing of the buckle. FIG. 6 shows only certain inner components of the strap and buckle for illustrative purposes. In the present embodiment, a first upper gear 405 contacts and mates with the strip of upper teeth 215 of the second end of the belt and a first lower gear 410 contacts and mates with the strip of lower teeth 220 of the second end of the belt. Note that said gear teeth are outwards facing and exposed to the outside viewer for aesthetic purposes. Note also that for illustration purposes only, in FIG. 7 the buckle 130 is shown to be somewhat transparent and/or see-through so as to illustrate the location of the belt within the buckle. Note that the buckle 130 is not actually transparent and/or see-through, as in FIG. 7, as this is solely for illustration purposes.

The first upper gear can be a spur gear such that when the strap is moved through the slot in the buckle the upper teeth of strap contact the first upper gear causing the first upper gear to rotate. Similarly, the first lower gear can be a spur gear such that the when the strap is moved through the slot in the buckle lower teeth of strap contact the first lower gear causing the first lower gear to rotate. The first upper gear is coupled to a first upper shaft 415 that is rotatably attached to the inside body of the buckle and is adapted such that the first upper shaft rotates when the first upper gear rotates. Similarly to the first upper gear, the first lower gear is coupled to a first lower shaft 420 that is rotatably attached to an inside portion of the buckle and is adapted such that the first lower shaft rotates when the lower first gear rotates. The upper and lower first gears may be made from or coated with rubberized material. The rubberized material allows the teeth of the gears and the teeth of the second end of the belt to more easily grip each other. Additionally, the teeth of the second end of the belt can be coated with or formed from rubberized material to more easily grip the teeth of the gears.

In the present embodiment, attached to the first upper shaft is a second upper gear 440. The second upper gear rotates when the first upper shaft rotates. Similar to the first shaft, attached to the first lower shaft is a second lower gear 450. The second lower gear rotates when the first lower shaft rotates. Both the second upper and lower gears are spur gears having a plurality of gear teeth.

In the present embodiment, the gear teeth of second upper gear contacts and mates with the gear teeth of a third upper gear 445. Similar to the second upper gear, the second lower gear 450 contacts and can mates with the gear teeth of a third lower gear 455. In the present embodiment, the gear teeth of the second upper gear mates and contacts with the gear teeth of the third upper gear such that the movement of the second upper gear moves the third upper gear. Similarly. The gear teeth of the second lower gear mates and contacts with the gear teeth of the third lower gear such that the movement of the second lower gear moves the lower third gear.

In the present embodiment, the gear teeth of the third upper gear 445 contacts and mates with the gear teeth of a fourth upper gear 460. Similar to the third upper gear, the third lower gear 455 contacts and mates with the gear teeth of a fourth lower gear 465. The gear teeth of the third upper gear mates and contacts with the gear teeth of the forth upper gear such that the movement of the third upper gear moves the fourth upper gear. The gear teeth of the third lower gear mates and contacts with the gear teeth of the fourth lower gear such that the movement of the third lower gear moves the fourth lower gear. The second, third and fourth upper gears can be rotatably attached by fasteners to support members 435 of the buckle. The support members can be integral with or affixed separately to the buckle and provide support to the buckle and allow for attaching the components inside the buckle. Such fasteners can be a pin, however other fasteners may also be used and are well known to those skilled in the art.

In the present embodiment, the spring loaded ratchet prevents the belt from being loosened unless a ratchet lever 475 moves the pawl or bar 320 of the ratchet causing the pawl to disengage or withdraw from the gear (more specifically illustrated in FIGS. 5 and 6). In the present embodiment, the pawl engages the teeth of the first upper gear, however it should understood that the buckle could be configured to have the pawl to engage other gears of the buckle. Additionally in other embodiments (not shown) only one gear having a plurality of gear teeth and one strip of linear or a horizontally arranged strip of teeth on the strap are used and required for operation of the invention.

In the present embodiment, the teeth of the first upper gear 405 can be uniform but asymmetrical. Each of the teeth can have a sloped side and a vertical side. In one embodiment, the pawl 320 can be a rectangular shaped bar having a first end opposing a second end. The first end of the pawl is a bar is rotatably affixed by a fastener, such as a pin, to a portion of the inside body of the buckle and the second end has a curved feature and a straight feature. A tension spring 425 abuts the pawl. The tension spring can be affixed, using a fastener such as a pin, bolt or screw, to a portion of the inside body of the buckle. The spring is positioned such that the spring pushes the pawl into the teeth of the first upper gear 405. A somewhat u-shaped lever is pivotally attached with a fastener so that a portion of the lever is accessible from the outside of the top end of the housing. When the lever is not activated or at rest, the force of the spring pushes the pawl causing the pawl to engage the teeth of the first upper gear.

The teeth and pawl are adapted such that in one direction, the pawl easily slides up and over the gently sloped edges of the teeth, with the tension spring forcing the pawl into the depression between the teeth as it passes the tip of each tooth. When the teeth move in the opposite (backward or when the adjustable belt is loosened) direction, however, the pawl will catch against the vertical side of the first tooth it encounters, thereby locking it against the tooth and preventing any further motion in that direction.

In order to allow movement in both directions, a user must activate the lever 475. The lever is activated by applying forces to move the lever in a direction such that the portion of the lever inside the body of the buckle pushes the pawl in a direction away from the teeth of the first upper gear and thereby compressing the tension spring. As the pawl 320 is pushed away the teeth of the gears can move in both directions.

In operation, the strap is positioned around an individual or user's waist. Next, the second end of the strap 100 is inserted into the slot of the buckle 130. As the second of the strap passes through the slot, the teeth 215 of the second end of the strap contact and move the teeth of the first gears 405, 410. As the teeth move, the pawl slides up and over the sloped edges of the teeth. The individual then tightens the strap into the desired position. When in the desired position, the tension spring 425 will push the pawl into the teeth such that the straight feature of the second end of the pawl engages the vertical side of the first tooth that it encounters and acts as a stop thereby preventing movement in the opposite direction (loosening of the belt).

To loosen the belt, an individual will apply force to raise the outside portion of the lever 475 in a direction such that the portion of the lever inside the body of the buckle pushes in a direction such that the pawl compresses the tension spring allowing the pawl to disengage from the teeth of the first gear. As the pawl disengages from the teeth, the second end of the belt can move in both directions and the belt can be loosened.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An adjustable belt for wearing around a user's waist, comprising:
a strap for placement around the user's waist, the strap having a first end, a second end and an outward facing surface when placed around the user's waist;
a plurality of gear teeth located on the outward facing surface of the strap;
a buckle coupled to a first end of the strap, the buckle configured for accepting a second end of the strap and adjusting a length of the strap around the user's waist, the buckle further comprising:
a plurality of gears having gear teeth that mate with the plurality of gear teeth located on the outward facing surface of the strap, such that movement of the second end of the strap within the buckle moves the plurality of gears;
a spring loaded ratchet that contacts the gear teeth of the plurality of gears, such that the ratchet only allows movement of the plurality of gears in one direction; and
a lever coupled to the spring loaded ratchet, such that activating the lever withdraws the ratchet from contacting the gear teeth of the plurality of gears, thereby allowing movement of the plurality of gears in both directions.

2. The adjustable belt from claim 1, wherein the gear teeth of the outward facing surface of the strap comprise a horizontally arranged strip of upper teeth opposite a horizontally arranged strip of lower teeth.

3. The adjustable belt from claim 1, wherein the buckle comprises a first upper gear that mates with the upper teeth and a first lower gear that mates with the lower teeth, wherein the first upper gear is coupled to a first upper shaft, wherein the upper shaft is coupled to a second upper gear, wherein the second upper gear mates with at least one additional gear, and wherein the first lower gear is coupled to a first lower shaft, wherein the first lower shaft is coupled to a second lower gear, wherein the second lower gear mates with at least one lower additional gear.

4. The adjustable belt of claim 1, wherein the first upper gear comprises a rubberized material.

5. The adjustable belt of claim 1, wherein the first lower gear comprises a rubberized material.

6. The adjustable belt of claim 1, wherein the gear teeth of the upper first gear are asymmetrical.

7. An adjustable belt for wearing around a user's waist, comprising:
a strap for placement around the user's waist, the strap having a first end, a second end and an outward facing surface when placed around the user's waist;
a plurality of gear teeth located on the outward facing surface of the strap, wherein the gear teeth of the outward facing surface of the strap comprise a horizontally arranged strip of upper teeth opposite a horizontally arranged strip of lower teeth;
a buckle coupled to a first end of the strap, the buckle configured for accepting a second end of the strap and adjusting a length of the strap around the user's waist, the buckle further comprising:
a plurality of gears having gear teeth that mate with the plurality of gear teeth located on the outward facing surface of the strap, wherein the plurality of gears includes a first upper gear that mates with the upper teeth and a first lower gear that mates with the lower teeth, wherein the first upper gear is coupled to a first upper shaft, wherein the upper shaft is coupled to a second upper gear, wherein the upper second gear mates with at least one additional gear, and wherein the first lower gear is coupled to a first lower shaft, wherein the first lower shaft is coupled to a second lower gear, wherein the second lower gear mates with at least one lower additional gear;
a spring loaded ratchet that contacts the gear teeth of the plurality of gears, such that the ratchet only allows movement of the plurality of gears in one direction; and
a lever coupled to the spring loaded ratchet, such that activating the lever withdraws a pawl of the ratchet from contacting the gear teeth of the plurality of gears, thereby allowing movement of the plurality of gears in both directions.

8. The adjustable belt of claim 7, wherein the upper gear is formed from a rubberized material.

9. The adjustable belt of claim 8, wherein the lower gear is formed a rubberized material.

10. The adjustable belt of claim 9, wherein the gear teeth of the upper gear are asymmetrical.

11. The adjustable belt of claim 7, wherein the gear teeth of at least one gear in the buckle are asymmetrical.

12. An adjustable belt for wearing around a user's waist, comprising:
a strap for placement around the user's waist, the strap having a first end, a second end and an outward facing surface when placed around the user's waist;
a plurality of gear teeth located on the outward facing surface of the strap;
a buckle coupled to a first end of the strap, the buckle configured for accepting a second end of the strap and adjusting a length of the strap around the user's waist, the buckle further comprising:
at least one gear having gear teeth that mate with the plurality of gear teeth located on the outward facing surface of the strap, such that movement of the second end of the strap within the buckle moves the at least one gear;
a movement prevention means only allows movement of the at least one gear in one direction; and
a lever proximate to the gear, such that activating the lever allows movement of the at least one gear in both directions.

13. The adjustable belt from claim 12, wherein the gear teeth of the outward facing surface of the strap comprise at least one horizontally arranged strip of teeth.

14. The adjustable belt of claim 12, wherein the at least one gear comprises a rubberized material.

15. The adjustable belt of claim 12, wherein the movement prevention means is a spring loaded ratchet.

16. The adjustable belt of claim 13, wherein the gear teeth of the at least one gear is asymmetrical.
